(19) United States
(12) Patent Application Publication
(10) Pub. No.: US 2015/0116200 A1
(43) Pub. Date: Apr. 30, 2015

(54) SYSTEM AND METHOD FOR GESTURAL CONTROL OF VEHICLE SYSTEMS

(71) Applicant: Honda Motor Co., Ltd., Tokyo (JP)

(72) Inventors: Fuminobu Kurosawa, San Jose, CA (US); Yoshiyuki Habashima, Redondo Beach, CA (US); Michael Eamonn Gleeson-May, San Francisco, CA (US); Arthur Alaniz, Mountain View, CA (US)

(73) Assignee: Honda Motor Co., Ltd., Tokyo (JP)

(21) Appl. No.: 14/159,401

(22) Filed: Jan. 20, 2014

Related U.S. Application Data
(60) Provisional application No. 61/895,552, filed on Oct. 25, 2013.

(51) Int. Cl. G06F 3/01

(52) U.S. Cl. CPC G06F 3/017
USPC 345/156

(57) ABSTRACT

A method and system for gestural control of a vehicle system including tracking a motion path of a grasp hand posture upon detecting an initiation dynamic hand gesture in a spatial location associated with the motorized vehicle system, wherein the initiation dynamic hand gesture is a sequence from a first open hand posture to the grasp hand posture, controlling a feature of the vehicle system based on the motion path and terminating control of the feature upon detecting a termination dynamic hand gesture, wherein the termination dynamic hand gesture is a sequence from the grasp hand posture to a second open hand posture.

This application claims priority to U.S. Provisional Application Ser. No. 61/895,552 filed on Oct. 25, 2013, which is expressly incorporated herein by reference.

### BACKGROUND

Interactive in-vehicle technology provides valuable services to all occupants of a vehicle. However, the proliferation of interactive in-vehicle technology can distract drivers from the primary task of driving. Thus, the design of automotive user interfaces (UIs) should consider design principles that enhance the experience of all occupants in a vehicle while minimizing distractions.

In particular, UIs have been incorporated within vehicles allowing vehicle occupants to control vehicle systems. For example, vehicle systems can include, but are not limited to, Heating Ventilation and Air-Conditioning systems (HVAC) and components (e.g., air vents and controls), mirrors (e.g., side door mirrors, rear view mirrors), heads-up-displays, entertainment systems, infotainment systems, navigation systems, door lock systems, seat adjustment systems, dashboard displays, among others. Some vehicle systems can include adjustable mechanical and electro-mechanical components. The design of UIs for vehicle systems should allow vehicle occupants to accurately, comfortably and safely interact with the vehicle systems while the vehicle is in non-moving and moving states.

### BRIEF DESCRIPTION

According to one aspect, a method for gestural control of a vehicle system, includes tracking a motion path of a grasp hand posture upon detecting an initiation dynamic hand gesture in a spatial location associated with the motorized vehicle system, wherein the initiation dynamic hand gesture is a sequence from a first open hand posture to the grasp hand posture. The method includes controlling a feature of the vehicle system based on the motion path and terminating control of the feature upon detecting a termination dynamic hand gesture, wherein the termination dynamic hand gesture is a sequence from the grasp hand posture to a second open hand posture.

According to another aspect, a system for gestural control in a vehicle includes a gesture recognition module tracking a motion path of a grasp hand posture upon detecting an initiation dynamic hand gesture in a spatial location associated with a vehicle system, wherein the initiation dynamic hand gesture is detected as a sequence from a first open hand posture to the grasp hand posture. The gesture recognition module detecting a termination dynamic hand gesture, wherein the termination dynamic hand gesture is detected as a sequence from the grasp hand posture to a second open hand posture. The system includes a gesture control module communicatively coupled to the gesture recognition module, wherein the control module controls a feature of the vehicle system based on the motion path.

According to a further aspect, a non-transitory computer-readable storage medium stores instructions that, when executed by a computer, causes the computer to perform the steps of tracking a motion path of a grasp hand posture upon detecting an initiation dynamic hand gesture in a spatial location associated with the motorized vehicle system, wherein the initiation dynamic hand gesture is a sequence from a first open hand posture to the grasp hand posture. The steps include generating a command to control a feature of the vehicle system based on the motion path and terminating control of the feature upon detecting a termination dynamic hand gesture, wherein the termination dynamic hand gesture is a sequence from the grasp hand posture to a second open hand posture.

### BRIEF DESCRIPTION OF THE DRAWINGS

FIG. 1 is a schematic view of an operating environment for systems and methods of gestural control of a vehicle system according to an exemplary embodiment;

FIG. 2 is a block diagram of a gesture recognition engine according to an exemplary embodiment;

FIG. 3 is a schematic view of dynamic hand gestures according to an exemplary embodiment;

FIG. 4A is a schematic view of gestural control of a door mirror assembly according to an exemplary embodiment showing a first open hand posture;

FIG. 4B is a detailed schematic view of the gestural control of a door mirror assembly like FIG. 4A but showing a motion path from an initiation dynamic hand gesture to a termination dynamic hand gesture;

FIG. 4C is a detailed schematic view of the gestural control of a door mirror assembly like FIGS. 4A and 4B but showing an amount of change between a position of the initiation dynamic hand gesture and the termination dynamic hand gesture;

FIG. 5 is a schematic view showing an amount of change between a position of the initiation dynamic hand gesture and the termination dynamic hand gesture according to an exemplary embodiment;

FIG. 6 is a schematic view showing exemplary motion paths according to an exemplary embodiment;

FIG. 7 is a schematic view of a passenger side door mirror assembly according to an exemplary embodiment;

FIG. 8 is a schematic view of an air vent assembly according to an exemplary embodiment; and

FIG. 9 is a flow-chart diagram of a method for gestural control of a motorized vehicle system according to an exemplary embodiment.

### DETAILED DESCRIPTION

The following includes definitions of selected terms employed herein. The definitions include various examples and/or forms of components that fall within the scope of a term and that can be used for implementation. The examples are not intended to be limiting.

A “bus”, as used herein, refers to an interconnected architecture that is operably connected to other computer components inside a computer or between computers. The bus can transfer data between the computer components. The bus can a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

An “input/output (I/O) device”, as used herein includes any program, operation or device that transfer data to or from a computer and to or from a peripheral devices. Some devices can be input-only, output-only or input and output devices. Exemplary I/O devices include, but are not limited to, a keyboard, a mouse, a display unit, a touch screen, a human-machine interface, a printer.

A “gesture”, as used herein, can be an action, movement and/or position of one or more vehicle occupants. The gesture can be made by an appendage (e.g., a hand, a foot, a finger, an arm, a leg) of the one or more vehicle occupants. Gestures can be recognized using gesture recognition and facial recognition techniques known in the art. Gestures can be static gestures of dynamic gestures. Static gestures are gestures that do not depend on motion. Dynamic gestures are gestures that require motion and are based on a trajectory formed during the motion.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

An “operable connection”, or a connection by which entities are “operably connected”, is one in which signals, physical communications, and/or logical communications can be sent and/or received. An operable connection can include a physical interface, a data interface and/or an electrical interface.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “vehicle”, as used herein, refers to any machine capable of carrying one or more human occupants and powered by any form of energy. The term “vehicle” includes, but is not limited to: cars, trucks, vans, minivans, airplanes, all-terrain vehicles, multi-utility vehicles, lawnmowers and boats.

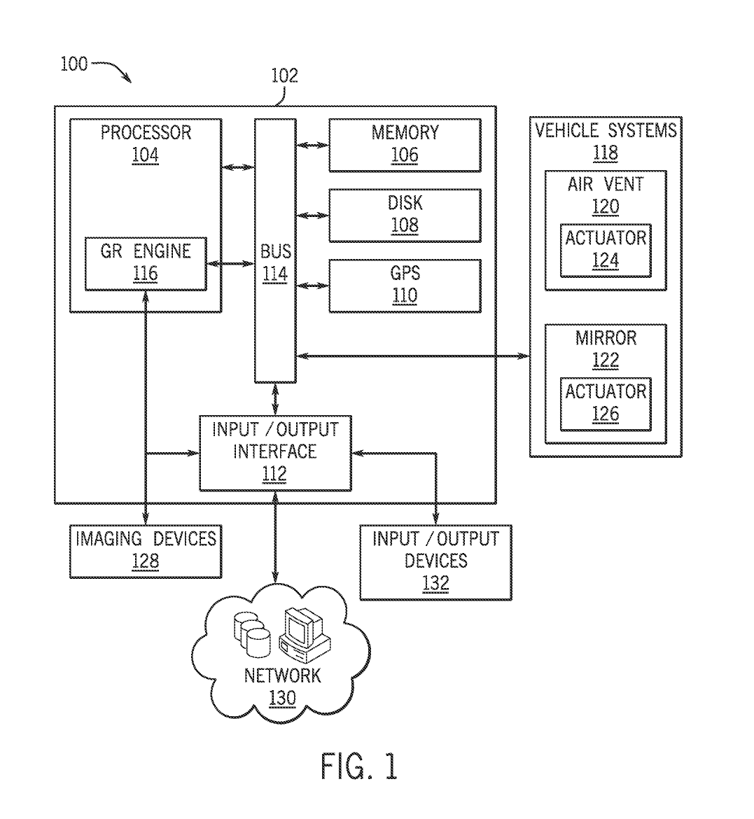

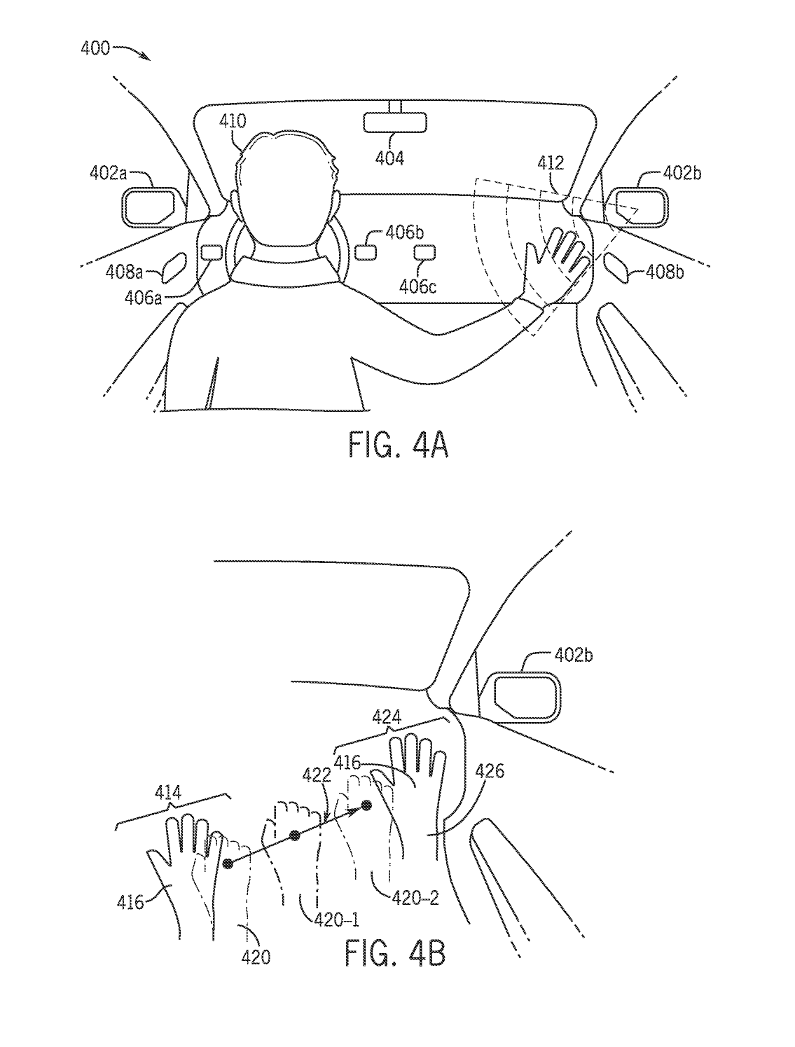

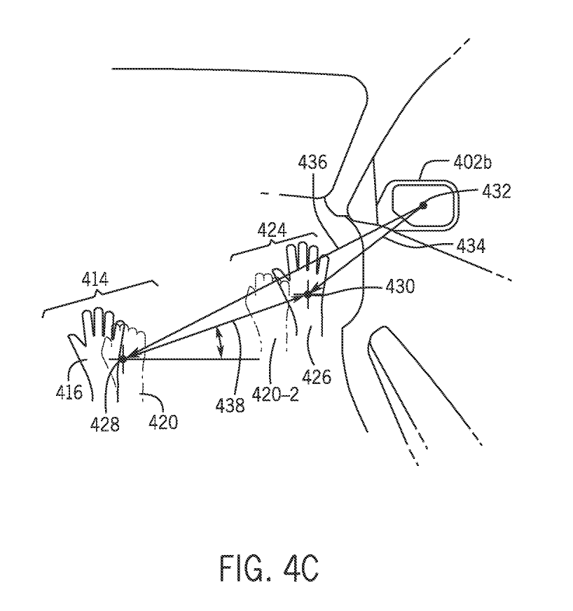

Referring now to the drawings, wherein the showings are for purposes of illustrating one or more exemplary embodiments and not for purposes of limiting same, FIG. 1 is a schematic view of an operating environment 100 for implementing a system and method for gestural control of a vehicle system. The components of environment 100, as well as the components of other systems, hardware architectures and software architectures discussed herein, can be combined, omitted or organized into different architectures for various embodiments. The components of environment 100 can be implemented with or associated with a vehicle (See FIGS. 4A, 4B and 4C).

With reference to FIG. 1, the environment 100 includes a vehicle computing device (VCD) 102 (e.g., a telematics unit, a head unit, a navigation unit, an infotainment unit) with provisions for processing, communicating and interacting with various components of a vehicle and other components of the environment 100. Generally, the VCD 102 includes a processor 104, a memory 106, a disk 108, a Global Positioning System (GPS) 110 and an input/output (I/O) interface 112, which are each operably connected for computer communication via a bus 114 (e.g., a Controller Area Network (CAN) or a Local Interconnect Network (LIN) protocol bus) and/or other wired and wireless technologies. The I/O interface 112 provides software, firmware and/or hardware to facilitate data input and output between the components of the VCD 102 and other components, networks and data sources, which will be described herein. Additionally, as will be discussed in further detail with the systems and the methods discussed herein, the processor 104 includes a gesture recognition (GR) engine 116 suitable for providing gesture recognition and gesture control of a vehicle system facilitated by components of the environment 100.

The VCD 102 is also operably connected for computer communication (e.g., via the bus 114 and/or the I/O interface 112) to a plurality of vehicle systems 118. The vehicle systems 118 can be associated with any automatic or manual vehicle system used to enhance the vehicle, driving and/or safety. The vehicle systems 118 can be non-motorized, motorized and/or electro-mechanical systems. For example, the vehicle systems 118 can include, but are not limited to, Heating Ventilation and Air-Conditioning systems (HVAC) and components (e.g., air vents and controls), mirrors (e.g., side door mirrors, rear view mirrors), heads-up-displays, entertainment systems, infotainment systems, navigation systems, door lock systems, seat adjustment systems, dashboard displays, touch display interfaces among others.

The vehicle systems 118 include features that can be controlled (e.g., adjusted, modified) based on hand gestures. Features can include, but are not limited to, door controls (e.g., lock, unlock, trunk controls), infotainment controls (e.g., ON/OFF, audio volume, playlist control), HVAC controls (e.g., ON/OFF, air flow, air temperature). As discussed above, in one embodiment, the vehicle systems 118 are motorized and/or electro-mechanical vehicle system. Thus, the vehicle systems 118 features that can be controlled include mechanical and/or electro-mechanical features as well non-mechanical or non-motorized features. In one embodiment, the vehicle systems 118 include movable components configured for spatial movement. For example, movable components can include, but are not limited to air vents, vehicle mirrors, infotainment buttons, knobs, windows, door locks. The vehicle features and movable components are configured for spatial movement in an X-axis, Y-axis and/or Z-axis direction. In another embodiment, the vehicle systems 118 and/or the moveable elements are configured for rotational movement about an X-axis, Y-axis and/or Z-axis. The systems and methods described herein facilitate direct gestural control and adjustment of one or more of the features (e.g., movable components) of the vehicle systems 118.

In one embodiment, the vehicle systems 118 can include an air vent assembly 120 and a mirror assembly 122. As will be discussed in further detail with FIGS. 4A, 4B and 4C the air vent assembly 120 can be located in the front interior vehicle cabin as a part of an HVAC system. The mirror assembly 122 can be a rearview mirror and/or a door mirror (e.g., a driver door mirror and/or a passenger door mirror). Generally, motorized and/or non-motorized vehicle systems 118 can each include an actuator with hardware, firmware and/or software for controlling aspects of each vehicle system 118. In one embodiment, a single actuator can control all of the vehicle systems 118. In another embodiment, the processor 104 can function as an actuator for the vehicle systems 118. In FIG. 1, the air vent assembly 120 includes an actuator 124 for controlling features of the air vent 120. Similarly, the mirror assembly 122 includes an actuator 126 for controlling features of the mirror assembly 122.

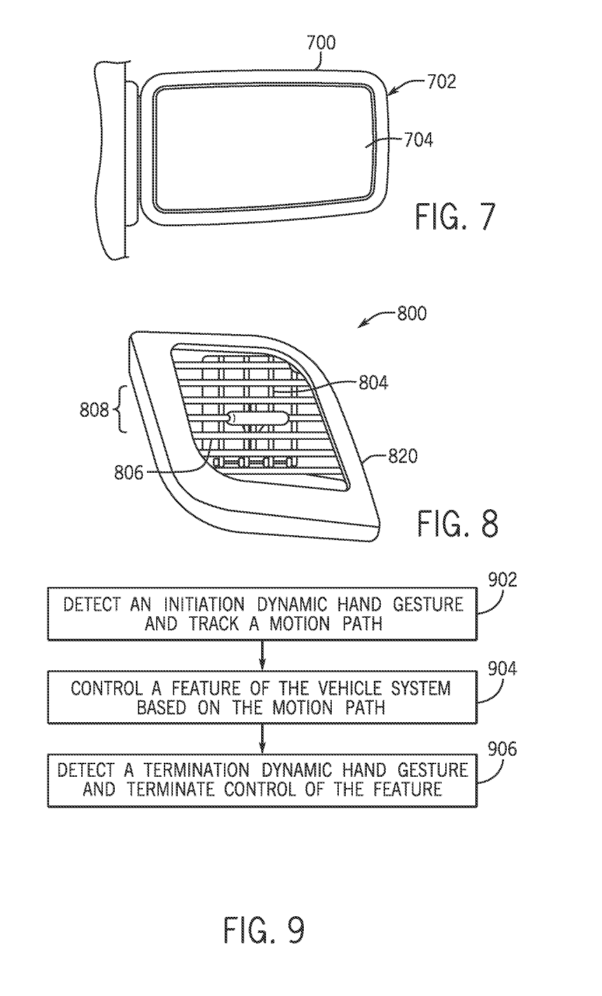

As discussed above, each of the vehicle systems 118 can include at least one movable component. For example, the air vent assembly 120 can include horizontal and vertical vanes, which are movable in response to gesture control. The mirror assembly 122 can include a mirror or a portion of a mirror that is movable in response to gesture control. The movable components of the air vent assembly 120 and the mirror assembly 122 will be discussed in more detail herein with reference to FIGS. 7 and 8.

As discussed previously, the vehicle systems 118 are configured for gestural control. The VCD 102, the GR engine 116 and the components of system 100 are configured to facilitate the gestural control. In particular, the VCD 102 is operably connected for computer communication to one more imaging devices 128. The imaging devices 128 are gesture and/or motion sensors that are capable of capturing still images, video images and/or depth images in two and/or three dimensions. Thus, the imaging devices 128 are capable of capturing images of a vehicle environment including one or more vehicle occupants and are configured to capture at least one gesture by the one or more vehicle occupants. The embodiments discussed herein are not limited to a particular image format, data format, resolution or size. As will be discussed in further detail, the processor 104 and/or the GR engine 116 are configured to recognize dynamic gestures in images obtained by the imaging device 128.

The VCD 102 is also operatively connected for computer communication to various networks 130 and input/output (I/O) devices 132. The network 130 is, for example, a data network, the Internet, a wide area network or a local area network. The network 130 serves as a communication medium to various remote devices (e.g., web servers, remote servers, application servers, intermediary servers, client machines, other portable devices). In some embodiments, image data for gesture recognition or vehicle system data can be obtained from the networks 130 and the input/output (I/O) devices 132.

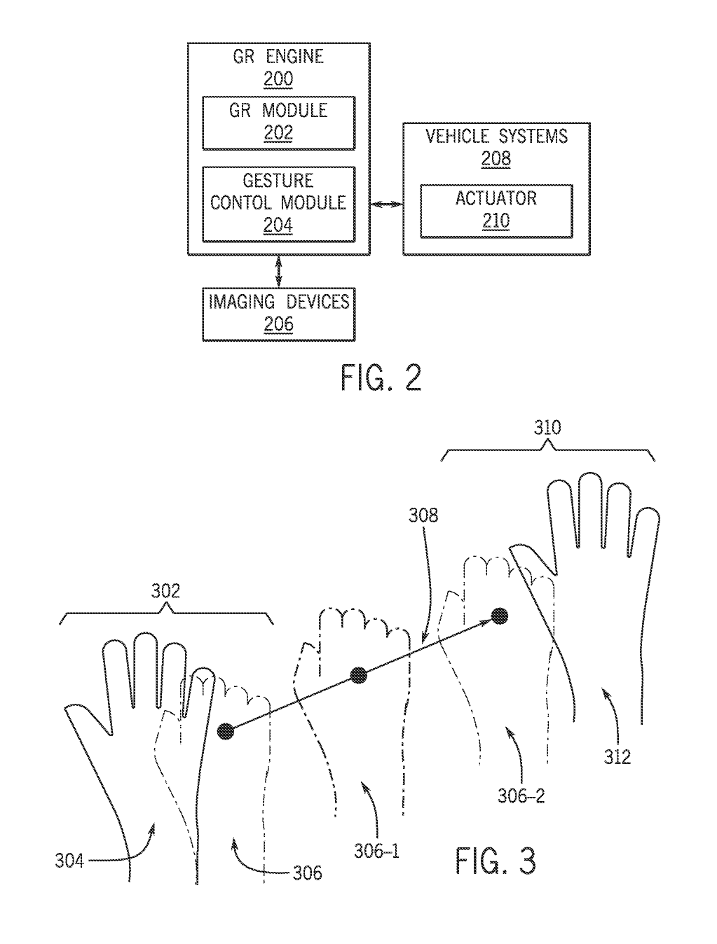

The GR engine 116 of FIG. 1 will now be discussed in detail with reference to FIG. 2. FIG. 2 illustrates a block diagram of a GR engine 200 (e.g., the GR engine 116) according to an exemplary embodiment. The GR engine 200 includes a gesture recognition (GR) module 202 and a gesture control module 204. In addition to the functionality described above with reference to FIG. 1, the aforementioned modules can access and/or receive images from imaging devices 206 (e.g., the imaging devices 128) and can communicate with vehicle systems 208 (e.g., the vehicle systems 118), including actuator 210 (e.g., actuator 124, 126) associated with the vehicle system 208.

In one exemplary embodiment, image data captured by the imaging devices 206 is transmitted to the GR module 202 for processing. The GR module 202 includes gesture recognition, tracking and feature extraction techniques to recognize and/or detect gestures from the image data captured by the imaging devices 206. In particular, the GR module 202 is configured to detect gestures and track motion of gestures for gestural control of the vehicle systems 208.

Exemplary gestures will now be described in more detail with reference to FIG. 3. As discussed herein, gestures can be static gestures and/or dynamic gestures. Static gestures are gestures that do not depend on motion. Dynamic gestures are gestures that require motion and are based on a trajectory formed during the motion. Dynamic gestures can be detected from a sequence of hand postures. FIG. 3 illustrates exemplary dynamic hand gestures comprising one or more hand postures and motion between the one or more hand postures. Throughout the description of the methods and systems herein, open hand postures and grasp hand postures will be described, however, other hand postures or sequences of hand postures (e.g., pointing postures, closed to open hand postures, finger postures) can also be implemented.

In FIG. 3, a sequence of hand postures and motions from an initiation dynamic hand gesture 302 to a termination dynamic hand gesture 310 is shown. The initiation dynamic hand gesture 302 includes a sequence of hand postures from a first open hand posture 304 (e.g., palm open gesture) to a grasp hand posture 306 (e.g., palm closed gesture, grasp gesture). The initiation dynamic hand gesture 302 generally indicates the start of gestural control of a vehicle system 208. The termination dynamic hand gesture 310 includes a sequence of hand postures from the grasp hand posture 306-2 to a second open hand posture 312 (e.g., palm open gesture). The termination dynamic hand gesture 310 generally indicates the end of gestural control of the vehicle system 208.

Upon detecting the initiation dynamic hand gesture 302, the GR module 202 tracks a motion path 308 from the initiation dynamic hand gesture 302 to the termination dynamic hand gesture 310. In another embodiment, the motion path 308 is a motion path from the first open hand posture 304 to the second open hand posture 312. In FIG. 3, the motion path 308 specifically includes the motion from the grasp hand posture 306, to the grasp hand posture 306-1 and finally to the grasp hand posture 306-2. The grasp hand posture 306-2 is part of the termination dynamic hand gestures 310.

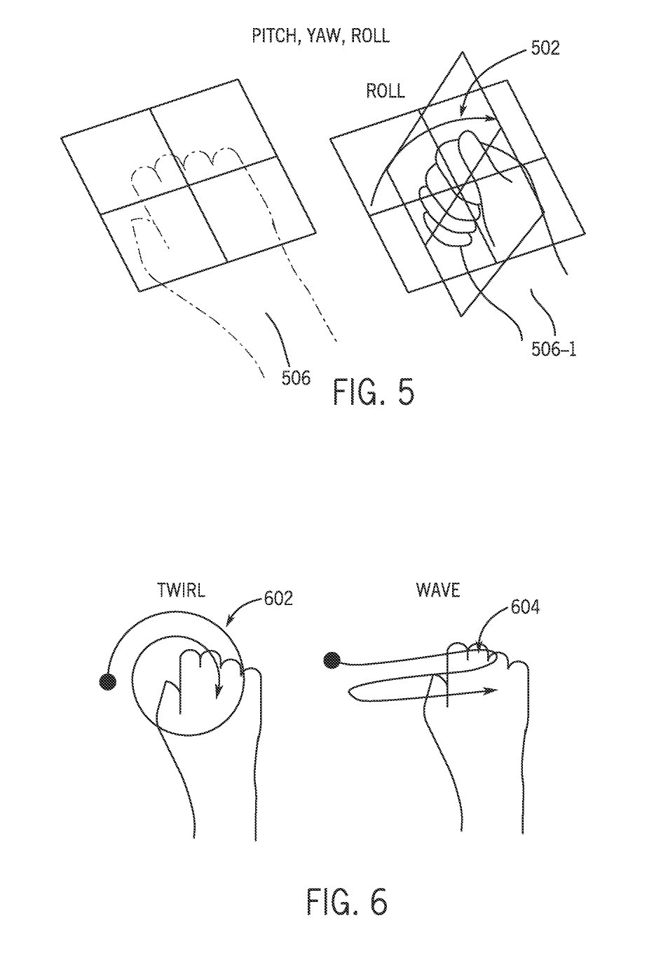

The motion path 308 defines a motion (e.g., direction, magnitude) in a linear or rotational direction. For example, the motion path 308 can define a motion in an x-axis, y-axis and/or z-axis direction and/or rotational movement about an x-axis, y-axis and/or z-axis. The motion path 308 can define a motion in one or more dimensional planes, for example, one, two or three-dimensional planes. In some embodiments, the motion path 308 can also indicate a direction and/or a magnitude (e.g., acceleration, speed). For example, in FIG. 5, the motion path 502 defines a pitch, yaw and roll motion from a grasp gesture 506 to the grasp gesture 506-1. In FIG. 6, the motion path 602 defines a trajectory of a twirl motion and a motion path 604 defines a trajectory of a wave motion. Further, individual features of the hand postures can also be tracked and defined by the motion path. For example, movement of one or more fingers of the hand postures.

Referring again to FIG. 2, in one embodiment, the GR module 202 tracks a motion path of a grasp hand posture upon detecting an initiation dynamic hand gesture. The initiation dynamic hand gesture indicates the start of gestural control of the vehicle system 208 and initiates operation of the GR engine 200. Upon recognition of the initiation dynamic hand gesture, the GR module 202 begins to track gestures in successive images from the imaging devices 206 to identify the gesture postures, positions and motion (e.g., the motion path 308). In one embodiment, the initiation dynamic hand gesture is detected as sequence from a first open hand posture to the grasp hand posture. For example, with reference to FIG. 3, the initiation dynamic hand gesture is indicated by element 302. Said differently, the initiation dynamic hand gesture can be detected as a motion from a first open hand posture 304 to the grasp gesture 306.

The GR module 202 is also configured to detect the initiation dynamic hand gesture in a spatial location, wherein the spatial location is associated with a vehicle system (i.e., the vehicle system to be controlled). The spatial location and the vehicle system associated with the spatial location can be determined by the GR module 202 through analysis of images received from the imaging devices 206. In particular, the GR module 202 can determine from the images which vehicle system or vehicle system component the initiation dynamic hand gesture is directed to or which motorized vehicle system is closest to a position of the initiation dynamic hand gesture. In another embodiment, the vehicle system and/or an imaging device associated with the vehicle system can utilize field-sensing techniques, discussed in detail with FIGS. 4A, 4B and 4C to determine an initiation dynamic hand gesture in a pre-defined spatial location associated with the vehicle system. In this embodiment, the actuator 210 can communicate with the GR engine 200 to indicate the spatial location associated with the vehicle system 208.

The GR module 202 is further configured to detect a termination dynamic hand gesture. The termination dynamic hand gesture indicates the end of gestural control of the motorized vehicle part 118. In one embodiment, the termination dynamic hand gesture is detected as sequence from the grasp hand posture 306-2 to the second open hand posture 312. For example, with reference to FIG. 3, the termination dynamic hand gesture is indicated by element 310. Said differently, the termination dynamic hand gesture can be detected as a motion from the grasp hand posture 306-2 to the second open hand posture 312.

Detection of the initiation dynamic hand gesture and the termination dynamic hand gesture will now be described with reference to the illustrative examples shown in FIG. 4A, FIG. 4B and FIG. 4C. FIG. 4A illustrates a schematic view of an interior of a front vehicle cabin 400 implementing a system and method for gestural control of a vehicle system. Exemplary vehicle systems that can be controlled by the systems and methods discussed herein include, but are not limited to, a driver side door mirror assembly 402a, a passenger side door mirror assembly 402b, a rear view mirror assembly 404, one or more air vent assemblies 406a, 406b, 406c, a driver side door lock 408a and a passenger side door lock 408b. Throughout the description of FIG. 4A, FIG. 4B and FIG. 4C, the systems and methods will be described in reference to gestural control of the passenger side door mirror assembly 402b by a driver 410. Specifically, the driver 410 directly controls adjustment of the passenger side door mirror assembly 402b via gestures. The system and methods discussed herein are also applicable to other vehicle systems, components and features as well as other vehicle occupants.

Referring now to FIG. 4A, the passenger side door mirror assembly 402b is a vehicle systems that includes one or more vehicle features that can be controlled by gestures. In one embodiment, the vehicle feature is a movable component of the vehicle system that is configured for spatial movement and can be adjusted via gestures. The mirror assembly 402b can include moveable components for adjustment. For example, referring to FIG. 7, a detailed schematic view of a mirror assembly (i.e., the mirror assembly 402b) is shown generally at element number 700. The mirror assembly 700 can include a housing 702 and a mirror 704. The mirror 704 is an exemplary moveable component of the mirror assembly 700 and can be adjusted in a linear or rotational x-axis, y-axis and/or z-axis direction in relation to the mirror housing 702. In another embodiment, the housing 702 can be adjusted in a linear or rotational x-axis, y-axis and/or z-axis direction in relation to the vehicle.

In yet another embodiment, an air vent assembly is adjusted via gestural control. FIG. 8 illustrates a detailed schematic view of an air vent assembly (i.e., the air vent assemblies 406a, 406b, 406c) shown generally at element number 800. The air vent assembly 800 can include a housing 802, vertical vanes 804 and horizontal vanes 806. The vertical vanes 804 and horizontal vanes 806 are movable components of the air vent assembly 800 that define the direction and amount of air flow output 608 from the air vent assembly 800. The vertical vanes 804 and the horizontal vanes 804 can be adjusted in an x-axis, y-axis, and/or z-axis direction in relation to the housing 802. In some embodiments, the speed of the airflow output 808 and/or the temperature of the airflow output 808 can be a vehicle feature controlled by gestures. In one embodiment, the airflow output speed and/or the airflow output temperature can be adjusted based on a translation of a motion path 602 in FIG. 6 (e.g. rotational movement about an x-axis, y-axis, and/or z-axis). For example, gestural control indicating rotational movement in a clockwise direction can increase the airflow output speed up to a maximum. In another embodiment, rotational movement in a counter-clockwise direction can indicate shutting off, or a partial reduction of the airflow output 808. The magnitude of the motion path (e.g., the motion path 602) can also be used to determine control of the vehicle feature, for example, the speed of airflow output 808.

Referring again to FIG. 4A, a spatial location 412 is associated with the mirror assembly 402b. The GR module 202 is configured to detect an initiation dynamic hand gesture in the spatial location 412 associated with the mirror assembly 402b. In the embodiment illustrated in FIG. 4A, field-sending techniques are used to determine the spatial location. Specifically, the spatial location 412 is a pre-defined spatial location associated with the mirror assembly 402b.

The initiation dynamic hand gesture indicates the start of gestural control of the mirror assembly 402b. In one embodiment, the initiation dynamic hand gesture is detected as a sequence from a first open hand posture to a grasp hand posture. In FIG. 4B, the initiation dynamic hand gesture is indicated by element 414 as a sequence from a first open hand posture 416 to a grasp hand posture 420. Upon detection of the initiation dynamic hand gesture, the GR module 202 tracks a motion path 422 of the grasp hand posture 420 to the grasp hand posture 420-1 and the grasp hand posture 420-2.

Further, the GR module 202 is configured to detect a termination dynamic hand gesture. The termination dynamic hand gesture indicates the end of gestural control of the mirror assembly 402b. In FIG. 4B, the termination dynamic hand gesture is indicated by element 424 as a sequence from the grasp hand posture 420-2 to a second open hand posture 426. The GR module 202 terminates tracking of the motion path 422 upon detecting the termination hand gesture.

Referring again to FIG. 2, the system also includes a gesture control module 204 that is communicatively coupled to the GR module 202. The gesture control module 204 controls a feature of the vehicle system 208 based on the motion path. In one embodiment, the gesture control module 204 communicates with the actuator 210 to selectively adjust an orientation of the vehicle system 208 based on the motion path. This communication can be facilitated by generating a control signal based on the motion path and transmitting the control signal to the vehicle system 208 (e.g., the actuator 210). The vehicle system 208 can then control a feature of the vehicle system based on the motion path and/or the control signal. As discussed herein, the feature to be controlled can be a movable component of the vehicle system 208. The actuator 210 can selectively adjust the feature based on the motion path and/or the control signal. In particular, the actuator 210 can selectively adjust an orientation (e.g., a position) of the moveable component based on the motion path. The actuator 210 can translate the motion path into the corresponding x-axis, y-axis and/or z-axis movements to selectively adjust the orientation.

The motion path used to control the vehicle feature can be determined in various ways. In one embodiment, tracking the motion path includes determine an amount of change between a position of the initiation dynamic hand gesture and a position of the termination dynamic hand gesture. For example, the GR module 202 determines a first control point based on a position of the initiation dynamic hand gesture and a second control point based on a position of the termination dynamic hand gesture. The gesture control module 204 further determines a difference between the first control point and the second control point. The motion path and/or the control signal can be based on the difference. In another embodiment, a displacement vector can be determined between the first control point and the second control point. The motion path and/or the control signal can be based on the displacement vector.

Referring now to FIG. 4C, a detailed schematic view of the gestural control of a door mirror assembly like FIGS. 4A and 4B but showing an amount of change between a position of the initiation dynamic hand gesture and the termination dynamic hand gesture is shown. The first control point 428 is determined using gesture recognition techniques implemented by the GR module 202. The first control point 428 is determined based on a position of the initiation dynamic hand gesture 414. In FIG. 4C, the first control point 428 is identified at a position of a grasp hand gesture 420. In another embodiment, the first control point 428 can be identified at a position of the first open hand posture 416 or another position identified within the initiation dynamic hand gesture 414. To determine the position of the first control point 428, the GR module 202 can determine a center of mass of the identified hand posture (e.g., the initiation dynamic hand gesture 414, the first open hand posture 416, the grasp hand posture 420) and set the first control point 428 to coordinates correlating to the position of the center of mass of the identified hand posture.

In another embodiment, the coordinates of the first control point 428 can also be based on a position of the vehicle system or the movable component to be controlled). For example, the first control point is determined by mapping a vector from a position of the initiation dynamic hand gesture to a position of the vehicle system. In FIG. 4C, a vector 436 is mapped between the first control point 428 and a position 432 of the mirror assembly 402b. In another embodiment, the first control point 428 can be determined based on mapping a vector (not shown) from a center of mass of the vehicle occupant (e.g., the head of the vehicle occupant; not shown), a position of the initiation dynamic hand gesture (e.g., the grasp hand posture 420) and a position of the vehicle system (e.g., point 432).

Similarly, the gesture control module 204 can determine a second control point 430 based on a position of the termination dynamic hand gesture 424. In one embodiment, the second control point 430 is determined using gesture recognition techniques implemented by the GR module 202. In FIG. 4C, the second control point 430 is identified at a position of the second open hand posture 426. In another embodiment, the second control point 430 can be identified at a position of the grasp hand posture 420-2 or another position identified within the termination dynamic hand gesture 424. For example, the GR module 202 can determine a center of mass of the identified hand posture (e.g., the termination dynamic hand gesture 424, the grasp gesture 420-2 and/or the second open hand posture 426) and set the second control point 430 to coordinates correlating to the position of the center of mass of the identified hand posture.

In another embodiment, the coordinates of the second control point 430 can be based on a position of the vehicle system (or vehicle component to be controlled). For example, the second control point 430 is determined by mapping a vector from a position of the termination dynamic hand gesture to a position of the vehicle system. In FIG. 4C, a vector 434 is mapped between the second control point 430 and a position 432 of the mirror assembly 402b. In another embodiment, the second control point 430 can be determined based on mapping a vector (not shown) from a center of mass of the vehicle occupant (e.g., the head of the vehicle occupant; not shown), a position of the termination dynamic hand gesture (e.g., the second open hand posture 4206) and a position of the vehicle system (e.g., point 432).

The gesture control module 204 can further determine a difference between the first control point 428 and the second control point 430. The motion path can be based on the difference between the first control point 428 and the second control point 430. In another embodiment, the gesture control module 204 can determine a displacement vector between the first control point 428 and the second control point 430. For example, in FIG. 4C, the displacement vector 438 is mapped between the first control point 428 and the second control point 430. The displacement vector 428 can indicate a change in distance and angle. The motion path can be based on the displacement vector 428.

As discussed above, the vehicle system 208 controls a feature of the vehicle system based on the motion path. Referring again to FIG. 4B, the gesture control module 204 communicates the motion path to the actuator 126 (FIG. 1) of the mirror assembly. In FIG. 4B, the motion path is in one embodiment, the displacement vector 438. In another embodiment, the motion path is the amount of change between a position of the initiation dynamic hand gesture 414 and the termination dynamic hand gesture 424. In one embodiment, the gesture control module 204 communicates the motion path to the actuator 126 by generating a control signal based on the motion path to the actuator 126. The actuator 126 of the mirror assembly 402b translates the control signal into x, y and z-axis movements to selectively adjust the orientation of the mirror assembly 402b.

In particular, in in the example shown in FIG. 4C, the orientation of at least one moveable element of the vehicle system is adjusted upon receipt of the control signal and/or the motion path. For example, the control signal and/or the motion path can cause the actuator 126 to adjust the orientation of the mirror assembly 402b in a two-axis direction, by adjusting the mirror along the x-axis and the y-axis. For example, referring to FIG. 7, the mirror 704 is a movable element of the mirror assembly 700. Similarly, in the case of the air vent assembly 800 (FIG. 8) the actuator 124 can adjust the orientation of the air vent assembly 800 in a two-axis direction, by adjusting the vertical vanes 804 in a y-axis direction and the horizontal vanes 806 in an x-axis direction. In another embodiment, the control signal can cause the actuator to adjust the airflow speed 808 according to a movement in an x-axis, y-axis and/or z-axis direction defined by the motion path. Further, the motion path can indicate a trajectory that does not include x-axis, y-axis and/or z-axis direction, but rather is an absolute path position. By providing control in a relative or absolute manner, a vehicle occupant can accurately and easily control vehicle systems through gestures.

The system for gestural control of a vehicle system as illustrated in FIGS. 1-8 and described above will now be described in operation with reference to a method of FIG. 9. The method of FIG. 9 includes, at block 902, tracking a motion path of a grasp hand posture upon detecting an initiation dynamic hand gesture in a spatial location associated with the motorized vehicle system. The initiation dynamic hand gesture is a sequence from a first open hand posture to the grasp hand posture. With reference to FIGS. 2, 4A, 4B and 4C the GR module 202 detects the initiation dynamic hand gesture 414 as a sequence from a first open hand posture 416 to the grasp hand posture 420. Upon detection of the initiation dynamic hand gesture, the GR module 202 tracks a motion path 422 of the grasp hand posture 420 to the grasp hand posture 420-1 and the grasp hand posture 420-2. In other embodiments, the motion path 422 can include a motion path between other hand postures and positions. For example, the motion path 422 can include a motion path from the grasp hand posture 420 to the second open hand posture 426. In FIG. 4B, the motion path 422 defines a motion from the grasp hand posture 420, to the grasp hand posture 420-1 and finally to the grasp hand posture 420-2. A termination dynamic hand gesture 424, discussed below in relation to block 906, includes the grasp hand posture 420-2. The motion path 422 can include a direction and/or a magnitude of the grasp hand posture 420. The motion path 422 is used to control a feature of a vehicle system.

The motion path 422 can be determined in various ways. In one embodiment, tracking the motion path comprises determining an amount of change between a position of the initiation dynamic hand gesture and a position of the termination dynamic hand gesture. Specifically, a first control point can be determined based on the position of the initiation dynamic hand gesture and a second control point can be based on the position of the termination dynamic hand gesture. The amount of change can be based on the first control point and the second control point.

With reference to FIG. 4C, the first control point 428 is determined using gesture recognition techniques implemented by the GR module 202. The first control point 428 is determined based on a position of the initiation dynamic hand gesture 414. In FIG. 4C, the first control point 428 is identified at a position of a grasp hand gesture 420. In another embodiment, the first control point 428 can be identified at a position of the first open hand posture 416 or another position identified within the initiation dynamic hand gesture 414. To determine the position of the first control point 428, the GR module 202 can determine a center of mass of the identified hand posture (e.g., the initiation dynamic hand gesture 414, the first open hand posture 416, the grasp hand posture 420) and set the first control point 428 to coordinates correlating to the position of the center of mass of the identified hand posture.

Similarly, the gesture control module 204 can determine a second control point 430 based on a position of the termination dynamic hand gesture 424. In one embodiment, the second control point 430 is determined using gesture recognition techniques implemented by the GR module 202. In FIG. 4C, the second control point 430 is identified at a position of the second open hand posture 426. In another embodiment, the second control point 430 can be identified at a position of the grasp hand posture 420-2 or another position identified within the termination dynamic hand gesture 424. For example, the GR module 202 can determine a center of mass of the identified hand posture (e.g., the termination dynamic hand gesture 424, the grasp gesture 420-2 and/or the second open hand posture 426) and set the second control point 430 to coordinates correlating to the position of the center of mass of the identified hand posture. An amount of change can be based on a difference between the first control point and the second control point.

In another embodiment, the motion path 422 is determined by mapping a first vector between the first control point and the second control point. For example, in FIG. 4C, a displacement vector 438 is mapped between the first control point 428 and the second control point 430. The displacement vector 428 can indicate a change in distance and angle. The motion path can be based on the displacement vector 428.

At block 904, the method includes controlling a feature of the vehicle system based on the motion path. Controlling the feature of the vehicle system can be executed in real-time based on the motion path. The vehicle system can be controlled by translating the amount of change and/or the first vector (i.e., the displacement vector 438) into directional movements for controlling the feature of the vehicle system. In one embodiment, the feature of the vehicle system can be a movable component of the vehicle system. Thus, controlling the moveable component can include controlling the movable component in an x-axis, y-axis, and/or z-axis direction based on the motion path.

Referring again to FIG. 4B, the gesture control module 204 communicates the motion path to the actuator 126 (FIG. 1) of the mirror assembly. In FIG. 4B, the motion path is in one embodiment, the displacement vector 438. In another embodiment, the motion path is the amount of change between a position of the initiation dynamic hand gesture 414 and the termination dynamic hand gesture 424. In one embodiment, the gesture control module 204 communicates the motion path to the actuator 126 by generating a control signal and/or a command based on the motion path to the actuator 126. The actuator 126 of the mirror assembly 402b translates the control signal into x, y and z-axis movements to selectively adjust the orientation of the mirror assembly 402b.

At block 906, the method includes terminating control of the feature upon detecting a termination dynamic hand gesture. The termination dynamic hand gesture is a sequence from the grasp hand posture to a second open hand posture. For example, in FIG. 4B, the termination dynamic hand gesture is indicated at element 424 and is a sequence of hand postures including the grasp hand posture 420-2 and the second open hand posture 426.

The embodiments discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer-readable storage media excludes non-transitory tangible media and propagated data signals.

Various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for gestural control of a vehicle system, comprising:
tracking a motion path of a grasp hand posture upon detecting an initiation dynamic hand gesture in a spatial location associated with the motorized vehicle system, wherein the initiation dynamic hand gesture is a sequence from a first open hand posture to the grasp hand posture;
controlling a feature of the vehicle system based on the motion path; and
terminating control of the feature upon detecting a termination dynamic hand gesture, wherein the termination dynamic hand gesture is a sequence from the grasp hand posture to a second open hand posture.

2. The method of claim 1, wherein tracking the motion path comprises determining an amount of change between a position of the initiation dynamic hand gesture and a position of the termination dynamic hand gesture.

3. The method of claim 2, comprising determining a first control point based on the position of the initiation dynamic hand gesture and determining a second control point based on the position of the termination dynamic hand gesture.

4. The method of claim 3, wherein the amount of change is based on the first control point and the second control point.

5. The method of claim 3, comprising mapping a first vector between the first control point and the second control point.

6. The method of claim 5, wherein controlling the feature of the vehicle system comprises translating the first vector into directional movements for controlling the feature of the vehicle system.

7. The method of claim 1, wherein controlling the feature of the vehicle system is executed in real-time based on the motion path.

8. The method of claim 1, wherein the feature of the vehicle system is a movable component of the vehicle system.

9. A system for gestural control in a vehicle, comprising:
a gesture recognition module tracking a motion path of a grasp hand posture upon detecting an initiation dynamic hand gesture in a spatial location associated with a vehicle system, wherein the initiation dynamic hand gesture is detected as a sequence from a first open hand posture to the grasp hand posture, and the gesture recognition module detecting a termination dynamic hand gesture, wherein the termination dynamic hand gesture is detected as a sequence from the grasp hand posture to a second open hand posture; and
a gesture control module communicatively coupled to the gesture recognition module, wherein the control module controls a feature of the vehicle system based on the motion path.

10. The system of claim 9, wherein the feature of the vehicle system is a movable component of the vehicle system.

11. The system of claim 10, wherein vehicle system comprises at least one actuator and the gesture control module communicates with the actuator to selectively adjust an orientation of the movable component based on the motion path.

12. The system of claim 11, wherein the gesture control module translates the motion path into x, y and z-axes movements.

13. The system of claim 9, wherein the gesture recognition module determines a first control point based on a position of the initiation dynamic hand gesture and a second control point based on a position of the termination dynamic hand gesture.

14. The system of claim 12, wherein the gesture control module determines a difference between the first control point and the second control point.

15. The system of claim 13, wherein the gesture control module determines a displacement vector between the first control point and the second control point.

16. The system of claim 9, wherein the motorized vehicle system is an air vent assembly.

17. A non-transitory computer-readable storage medium storing instructions that, when executed by a computer, causes the computer to perform the steps of:
tracking a motion path of a grasp hand posture upon detecting an initiation dynamic hand gesture in a spatial location associated with the motorized vehicle system, wherein the initiation dynamic hand gesture is a sequence from a first open hand posture to the grasp hand posture;
generating a command to control a feature of the vehicle system based on the motion path; and
terminating control of the feature upon detecting a termination dynamic hand gesture, wherein the termination dynamic hand gesture is a sequence from the grasp hand posture to a second open hand posture.

18. The non-transitory computer-readable storage medium of claim 17, wherein the feature of the vehicle system is a movable component of the vehicle system and the command to control the feature comprises a command to adjust the moveable component in an x, y and z axes direction.

19. The non-transitory computer-readable storage medium of claim 17, wherein the command to control the feature of the vehicle system is executed in real-time based on the motion path.

20. The non-transitory computer-readable storage medium of claim 17, wherein generating the command comprises providing the command to an actuator of the vehicle system.
